(19) United States
(12) Patent Application Publication
(10) Pub. No.: US 2024/0342812 A1
(43) Pub. Date: Oct. 17, 2024

(54) STRUT SHEARING TOOL AND DIES THEREFOR

(71) Applicant: MILWAUKEE ELECTRIC TOOL CORPORATION, Brookfield, WI (US)

(72) Inventors: Ryan G. Meves, Oak Creek, WI (US); Robert W. Butzen, Colgate, WI (US); Nathaniel P. Olbrich, Milwaukee, WI (US)

(21) Appl. No.: 18/293,591

(22) PCT Filed: Aug. 1, 2022
(86) PCT No.: PCT/US2022/039062

§ 371 Date: Jan. 30, 2024

Related U.S. Application Data
(60) Provisional application No. 63/304,254, filed on Jan. 28, 2022.
(60) Provisional application No. 63/227,765, filed on Jul. 30, 2021.

(51) Int. Cl. B23D 35/00; B23D 23/00

(52) U.S. Cl. CPC B23D 35/002; B23D 23/00

(57) ABSTRACT

A shearing tool for shearing a strut channel includes a housing, a drive casing coupled to the housing, an output movable along a longitudinal axis relative to the drive casing between an extended position and a retracted position, and a die. The die includes a front face, a rear face opposite the front face, and a cutout extending through the front and rear faces, the cutout configured to receive the strut channel therethrough. A die retaining mechanism is movable between a locked configuration, in which the die retaining mechanism couples the die to the output for movement therewith between the extended position and the retracted position, and an unlocked configuration, in which the die is removable from the drive casing. The die retaining mechanism is movable from the locked configuration to the unlocked configuration without the use of tools.

### CROSS-REFERENCE TO RELATED APPLICATIONS

This application claims priority to co-pending U.S. Provisional Patent Application No. 63/227,765, filed Jul. 30, 2021, and to co-pending U.S. Provisional Patent Application No. 63/304,254, filed Jan. 28, 2022, the entire content of each of which is incorporated herein by reference.

### FIELD

The present disclosure relates to a shearing tool and a dies therefore, for shearing a workpiece, such as strut channel.

### BACKGROUND

Strut channel (or simply, “strut”) is typically cut to length with a saw. Such sawing may cause burrs or sharp edges on the ends of the strut channel and threaded rod. The burrs or sharp edges are filed or ground down to remove them. This is a time-consuming process. Additionally, the sawing process may produce an undesirable cut end that is not perpendicular to the longitudinal direction.

Shearing tools, examples of which are described and illustrated in U.S. Pat. No. 10,576,557, which is hereby incorporated by reference in its entirety, have been used as an alternative to sawing. These tools use adjacent dies to hold the strut while it is being sheared. During the shearing process, the remaining feed stock can be deformed, which can create a problem feeding the feedstock into the adjacent die.

Accordingly, a need exists for improved shearing tools and dies that reduce deformation and improve the quality of cut strut channel.

### SUMMARY

The present disclosure provides, in one aspect, a shearing tool for shearing a strut channel. The shearing tool includes a housing, a drive casing coupled to the housing, an output movable along a longitudinal axis relative to the drive casing between an extended position and a retracted position, and a die. The die includes a front face, a rear face opposite the front face, and a cutout extending through the front and rear faces, the cutout configured to receive the strut channel therethrough. A die retaining mechanism is movable between a locked configuration, in which the die retaining mechanism couples the die to the output for movement therewith between the extended position and the retracted position, and an unlocked configuration, in which the die is removable from the drive casing. The die retaining mechanism is movable from the locked configuration to the unlocked configuration without the use of tools.

In some embodiments, the die removable from the drive casing through an open end of the drive casing.

In some embodiments, the open end is disposed opposite the output.

In some embodiments, the die includes a bore extending through the front face and the rear face.

In some embodiments, the die retaining mechanism includes a die retaining pin received in the bore when the die retaining mechanism is in the locked configuration.

In some embodiments, the die retaining pin is withdrawn from the bore when the die retaining mechanism is in the unlocked configuration.

In some embodiments, the bore is a first bore, and wherein the die includes a second bore extending through the front face and the rear face.

In some embodiments, the die is reversible such that the die retaining pin is received in the first bore when the die is in a first orientation and received in the second bore when the die is in a second orientation.

In some embodiments, the die retaining pin is supported on an arm pivotally coupled to the output.

In some embodiments, the die includes a first bore extending through the front face and the rear face, and a second bore extending through the front face and the rear face.

In some embodiments, the cutout includes a back receiving portion configured to receive a back side of the strut channel, side receiving portions extending from the back receiving portion and configured to receive opposite sides of the strut channel, and hook-shaped lip receiving portions configured to receive lips of the strut channel.

In some embodiments, the back receiving portion and the side receiving portions define a first width, and wherein the lip receiving portions define a second width greater than the first width.

In some embodiments, the second width is between 45% and 75% greater than the first width.

In some embodiments, the die includes chamfers formed in the front face of the die on both inner and outer sides of the cutout.

In some embodiments, the chamfers define an included angle relative to the front face of the die between 30 degrees and 60 degrees.

The present disclosure provides, in another aspect, a shearing tool for shearing a strut channel. The shearing tool includes a housing, a drive casing coupled to the housing, an output movable along a longitudinal axis relative to the drive casing between an extended position and a retracted position, and a die. The die includes a front face, a rear face opposite the front face, and a cutout extending through the front and rear faces, the cutout configured to receive the strut channel therethrough. A die retaining mechanism is movable between a locked configuration, in which the die retaining mechanism couples the die to the output for movement therewith between the extended position and the retracted position, and an unlocked configuration, in which the die is removable from the drive casing. The die is reversible relative to the drive casing such that the die is coupleable to the output via the die retaining mechanism in both a first orientation and a second orientation.

In some embodiments, the die removable from the drive casing through an open end of the drive casing opposite the output.

In some embodiments, the die includes a first bore extending through the front face and the rear face, and a second bore extending through the front face and the rear face.

In some embodiments, the die retaining mechanism includes a die retaining pin received in the first bore when the die retaining mechanism is in the locked configuration and the die is in the first orientation and received in the second bore when the die retaining mechanism is in the locked configuration and the die is in the second orientation.

The present disclosure provides, in another aspect, a die for shearing a strut channel. The die includes a front face, a rear face opposite the front face, a cutout extending through the front and rear faces, the cutout including a back receiving portion configured to receive a back side of the strut channel, side receiving portions extending from the back receiving portion and configured to receive opposite sides of the strut channel, and lip receiving portions configured to receive lips of the strut channel. The die includes chamfers formed in the front face of the die on both inner and outer sides of the cutout.

In some embodiments, the back receiving portion and the side receiving portions define a first width, and wherein the lip receiving portions define a second width greater than the first width.

In some embodiments, the second width is between 45% and 75% greater than the first width.

In some embodiments, the chamfers define an included angle relative to the front face of the die between 30 degrees and 60 degrees.

Other features and aspects of the disclosure will become apparent by consideration of the following detailed description and accompanying drawings.

### BRIEF DESCRIPTION OF THE DRAWINGS

FIG. 1 is front view of a die according to an embodiment of the present disclosure.

FIG. 2 is a front perspective view of the die of FIG. 1.

FIG. 3 is a rear perspective view of the die of FIG. 1.

FIG. 4 is a cross-sectional view of the die of FIG. 1.

FIG. 5 is a side view of a portion of a shearing tool according to an embodiment of the present disclosure.

FIG. 6 is an end view of the shearing tool of FIG. 5.

FIG. 7 is an enlarged end view of the shearing tool of FIG. 5, with a die removed.

FIG. 8 is a front view of a die according to an embodiment of the present disclosure, usable with the shearing tool of FIG. 5.

FIG. 9 is an enlarged perspective view illustrating the die of FIG. 8 in the shearing tool of FIG. 5.

FIG. 10 illustrates a die according to another embodiment of the present disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

Referring generally to the FIGURES, the present disclosure provides, in some aspects, a shearing tool including a housing with a drive casing into which a movable die can be positioned. The die may include chamfers leading into openings allowing partially deformed strut channel feedstock to be biased or directed towards the opening (e.g., when initially not aligned). A force transmitting apparatus moves the movable die relative to a stationary die to shear the workpiece. The movable die can be removed from the housing by unlocking a die retaining mechanism. In some embodiments, the movable die is reversible, which facilitates installation of the die into the shearing tool.

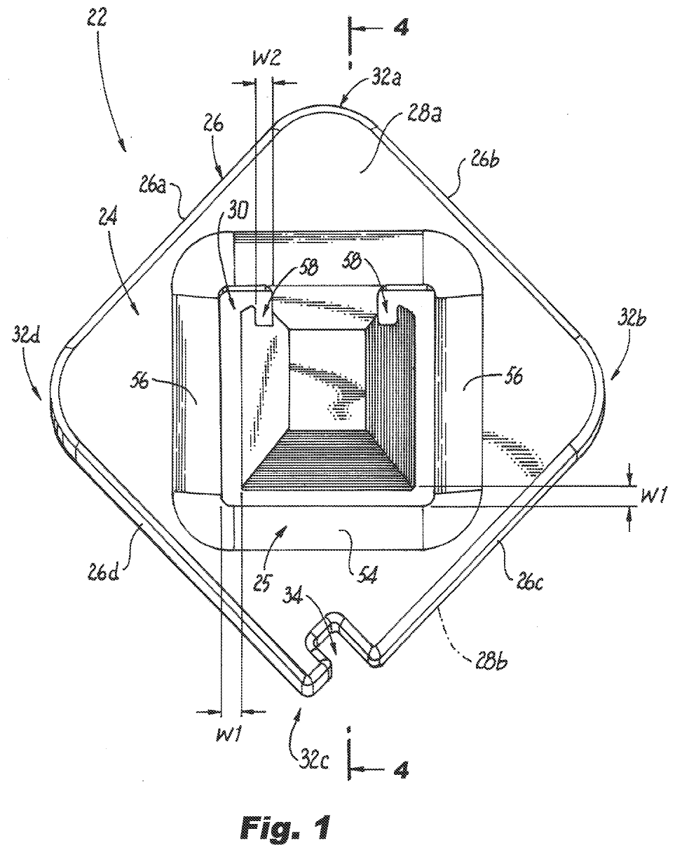

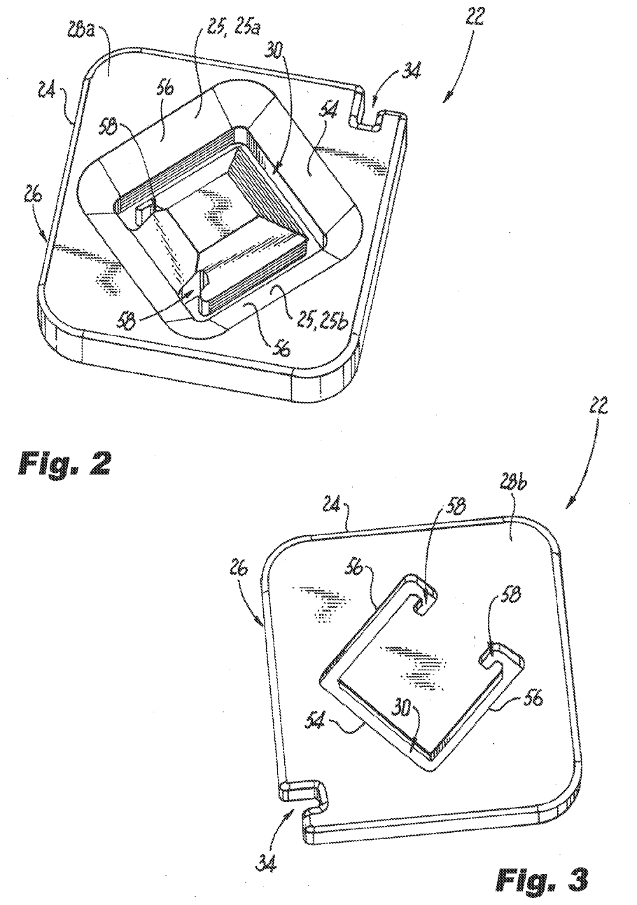

FIGS. 1-4 illustrate a die 22 formed of a plate 24 having an outer perimeter defined by an outer edge 26. The die 22 has a first or front planar face 28a (FIG. 2), and second or rear planar face 28b opposite the front face 28a (FIG. 3). A cutout 30 is provided through the die 22, such that the cutout 30 extends through the front face 28a and the rear face 28b. A thickness of the die 22 is defined between the faces 28a, 28b, such that the cutout 30 extends entirely through the thickness of the die 22.

It is contemplated that the cutout 30 may be formed through the use of a mold, or through cutting means including but not limited to mechanical cutting, laser cutting, CNC machining, water jet cutting, or hydraulic cutting, or through punch pressing means. The cutout 30 is sized to fittingly accommodate a workpiece having a cross-sectional shape similar to at least a portion of the cutout 30. It should be understood that in other embodiments, the cutout 30 may take a variety forms other than the one illustrated. In the illustrated embodiment, the die 22 is formed of tool steel, which advantageously provides the die 22 with sufficient hardness and durability for repeated shearing of metal struts.

As shown in FIG. 1, the outer edge 26 of the illustrated die 22 includes a first straight edge portion 26a, a second straight edge portion 26b extending from an end of the first edge portion 26a, a third straight edge portion 26c extending from the opposite end of the second edge portion 26b, and a fourth straight edge portion 26d extending from the opposite end of the third edge portion 26c. In some embodiments, the outer edge 26 generally forms a square or a rectangle such that the first and second straight edge portions 26a, 26b are perpendicular to each other and connected at a corner 32 a, the second and third straight edge portions 26b, 26c are perpendicular to each other and are connected at a corner 32b, the third and fourth straight portions 26c, 26d are perpendicular to each other and are connected at a corner 32c, and the first and fourth straight portions 26a, 26d are perpendicular to each other and are connected at a corner 32d. In some embodiments, some or all of the corners 32a, 32b, 32c, 32d are radiused. In the illustrated embodiment, the corner 32c is interrupted by or replaced by groove 34. The groove 34 may take other shapes, such as a squared off shape, triangular shape, etc. This groove 34 may be used to properly position and/or retain the die 22 within the shearing tool.

The cutout 30 shown in the figure may be used to cut strut channel. The illustrated cutout 30 includes a back receiving portion 54, side receiving portions 56 and lip receiving portions 58. The back receiving portion 54 accommodates a back side of a strut channel to be cut and is shaped accordingly: the side receiving portions 56 accommodate opposite sides of the strut channel and are shaped accordingly: the lip receiving portions 58 accommodate respective lips of the strut channel and are shaped accordingly.

For example, in the illustrated embodiment, the lip receiving portions 58 generally form hook-shapes to accommodate generally hook-shaped ends of the strut channel. During the strut channel manufacturing process or due to damage during transport, the lips of the strut channel often become deformed from jarring and can be difficult to slide through a cutout in die profiles. As described in more detail below, the illustrated die 22 includes enlarged lip receiving portions 58 to allow deformed ends of the strut channels to pass therethrough, and the die 22 also includes chamfers 25 in the front surface 28a to more easily direct deformed edges of the strut channel into the cutout 30 of the die 22.

Referring to FIG. 1, the back receiving portion 54 and the side receiving portions 56 of the cutout 30 have a width (or widths) W1, which closely conforms to the width of the strut channel being cut. The lip receiving portions 58 have a width W2, which is larger than the width of the lips of the strut channel being cut. In some embodiments, the lip receiving portions 58 have a width W2 which is about 60% greater than the width of the lips of the strut channel, and thus, in some embodiments, the width W2 is about 60% greater than the width W1. In some embodiments, the width W2 is between 45% and 75% greater than the width W1. This allows for deformed lips of the strut channel to easily slide through the die 22.

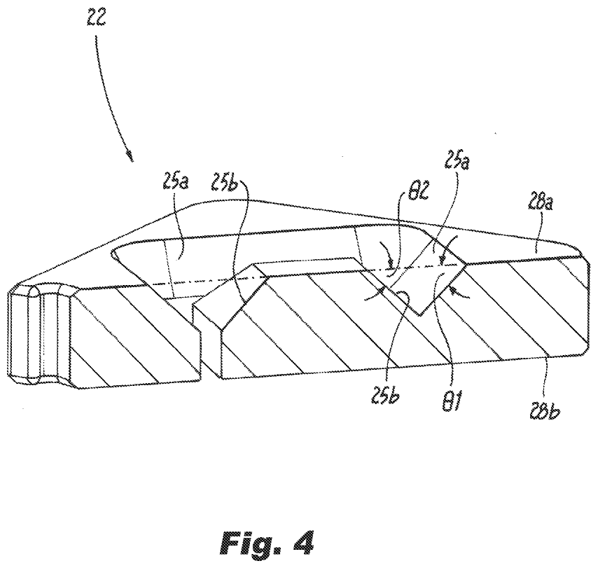

With reference to FIGS. 2 and 4, chamfers 25 are formed in the front surface 28a of the die 22. In the illustrated embodiment, the chamfers 25 are positioned on both sides (i.e. the inner and outer sides) of the cutout 30, along the back receiving portion 54 and both side receiving portions 56. As shown in FIG. 4, in the illustrated embodiment, the chamfers 25a on the outer side of the cutout 30 define a first angle θ1 relative to the front surface 28a of the die 22, and the chamfers 25b on the inner side of the cutout 30 define a second angle θ2 relative to the front surface 28a of the die 22. In the illustrated embodiment, the first angle θ1 and the second angle θ2 are equal. The first angle θ1 and the second angle θ2 are between 30 degrees and 60 degrees, and preferably 45 degrees. The chamfers 25a, 25b may extend at least 25% of the thickness of the die 22, or at least 40% of the thickness of the die 22 in some embodiments. The chamfers 25a, 25b and the cutout 30 together generally form a funnel shape extending through the thickness of the die 22. In the illustrated embodiment the chamfers 25a, 25b have a linear (i.e. constant slope), but the chamfers 25a. 25b may be curved or may include multiple slopes in other embodiments.

During the strut channel manufacturing process or due to warping during storage or transport, the sides of the strut channel may bend inwards or outwards away from their nominal perpendicular position relative to the channel back. In some embodiments, the chamfers are only provided along the edges needed based upon expected deformation discussed in the previous sentence. However, in other embodiments, chamfers 25 are provided along all portions 54, 56, 58 of the cutout 30 on one side (e.g., the front side 28a) of the die 22. In some embodiments, the chamfers 25 extend at least a length (from the edge of the cutout in a generally perpendicular direction) equal to the width of the strut channel being cut. In other embodiments, the chamfers 25 extends for a length between 1 and 3 times the width of the strut channel being cut. In yet other embodiments, the chamfers 25 extend more than 3 times the width of the strut channel being cut.

In use, a previously sheared end of a strut, which is somewhat deformed compared to its pre-sheared shape, may not properly align with one or more portions 54, 56, 58 of the cutout 30. As this deformed end is fed toward the die 22, the deformed end engages the chamfer 25. This engagement along with continued force in the feeding direction guides and forces the deformed portions of the strut into alignment with the respective portions 54, 56, 58 of the cutout 30, allowing the strut to be fed into and through the die 22 for the next cutting operation to be performed.

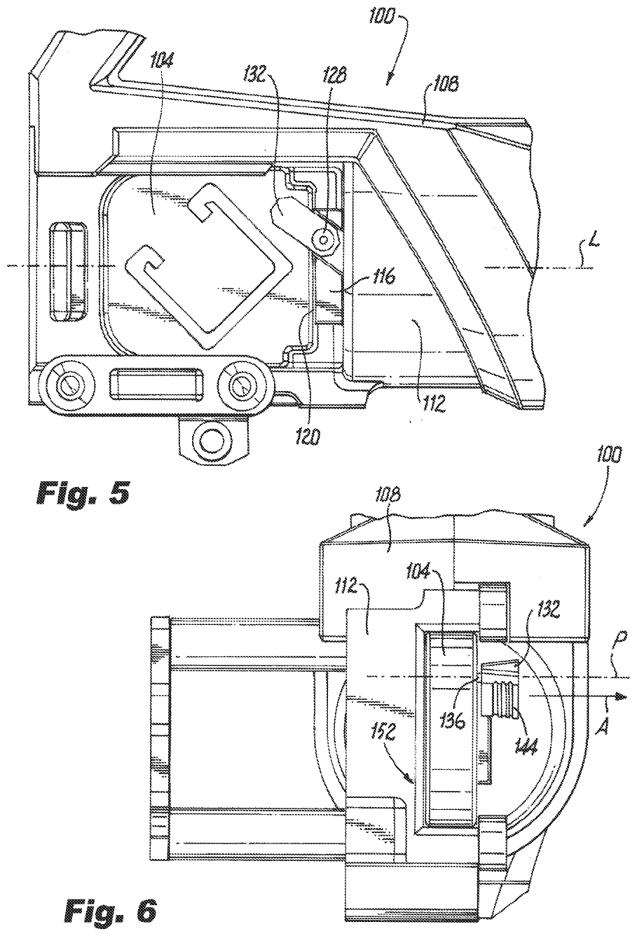

FIGS. 5 and 6 illustrate a shearing tool 100 operable to reciprocate a die 104 to cut/shear a section of strut channel. The die 104 may be similar to the die 22 described above with reference to FIGS. 1-4. For example, the die 104 may optionally include chamfers 25. In other embodiments, the shearing tool 100 may be configured for use with the die 22, and the die 22 may optionally include features of the die 104.

The shearing tool 100 includes a housing 108, a drive casing 112 coupled to the housing 108, and an output 116 (which may also be referred to as an output shaft) movable along a longitudinal axis L relative to the drive casing 112 between an extended position (not shown) and a retracted position (shown in FIG. 5). In some embodiments, the output shaft 116 may be a hydraulic ram, coupled to or integrally formed with a piston and movable under the influence of pressurized hydraulic fluid (e.g., as part of a single or double-acting hydraulic cylinder assembly). In other embodiments, the output shaft 116 may be driven by a power screw mechanism, a cam and follower mechanism, or any other drive mechanism suitable for moving the output shaft 116 between the retracted and extended positions. The drive mechanism preferably includes an electric motor powered by a battery (e.g., a removable and rechargeable power tool battery pack: not shown).

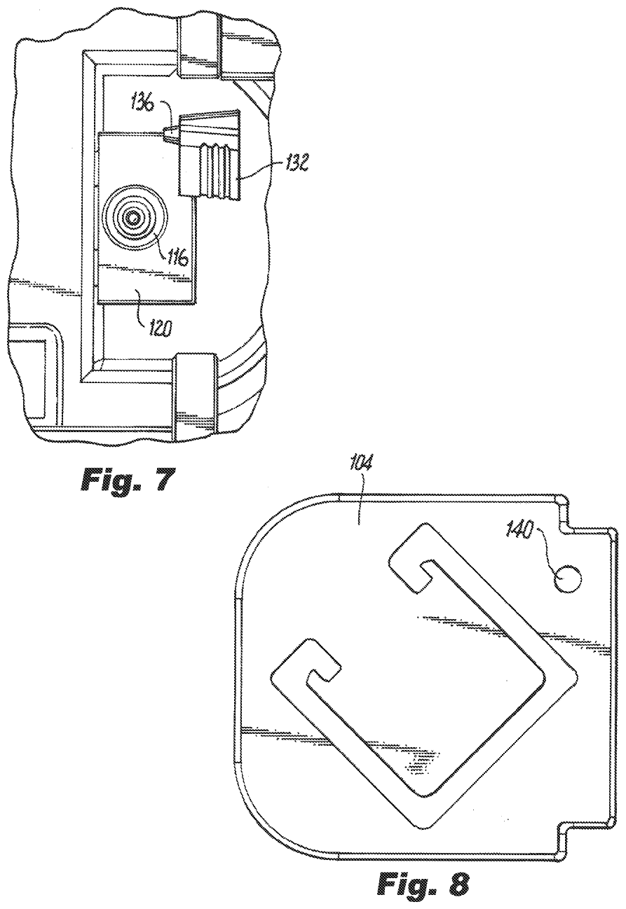

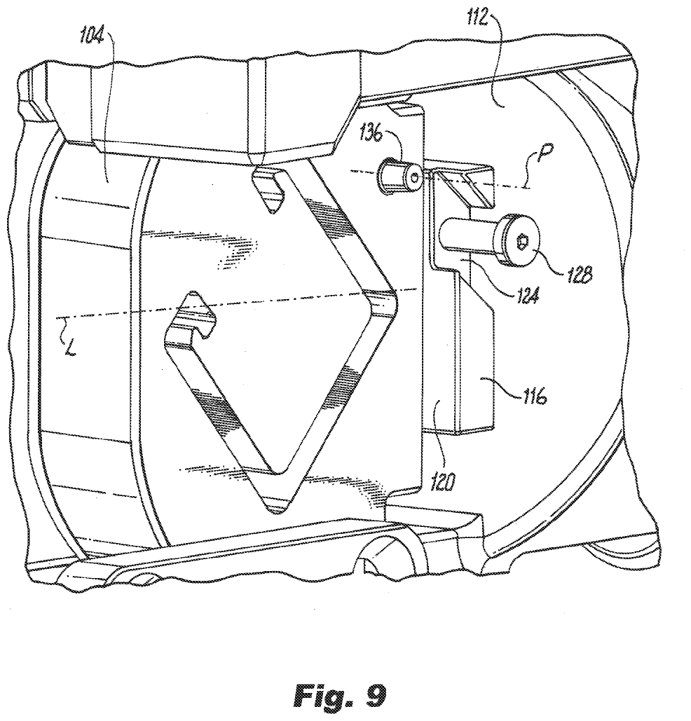

Best illustrated in FIG. 9, the output shaft 116 includes a shoulder 120 that abuts a drive side of the die 104 and an angled recess or slot 124 extending at an oblique angle (e.g., a 45 degree angle) relative to the longitudinal axis L. A first pin 128 is coupled to the output shaft 116 and extends transversely from the center of the angled slot 124. Referring to FIGS. 5-7, a retaining arm 132 is pivotally coupled to the first pin 128. The illustrated retaining arm 132 has a first end portion that receives the first pin 128 therethrough, and a second end portion opposite the first end portion. A second pin 136, or die retaining pin 136, is fixed to and extends from the second end portion. The first pin 128, retaining arm 132, and second pin 136 define a die retaining mechanism. As described in greater detail below, the die retaining mechanism is configured to removably couple the die 104 to the output shaft 116 and to allow for efficient, tool-free removal and replacement of the die 104.

The illustrated die 104 includes a bore 140 extending through the front and rear faces of the die 104 (i.e. extending entirely through the thickness of the die 104). The bore 140 is cylindrical in the illustrated embodiment, and is sized and shaped to receive the die retaining pin 136. In other embodiments, the bore 140 may have other shapes, including but not limited to a square shape or frustoconical shape. In some embodiments, the bore 140 may be a blind bore extending only partially into the body of the die 104.

In operation, a section of strut channel to be cut is fed into the die 104 until the die reaches a desired cutting position along the length of the strut channel. The shearing tool 100 is then operated, causing the output shaft 116 to advance toward the extended position along the longitudinal axis L (i.e. to the left in FIG. 5). As the output shaft 116 advances, the shoulder 120 abuts the die 104 and moves the die 104 together with the output shaft 116, thereby shearing the strut channel.

Once the shearing operation is completed, the output shaft 116 retracts to reset the shearing tool 100 for a subsequent shearing operation. As the output shaft 116 retracts along the longitudinal axis L (i.e. to the right in FIG. 5), the retaining arm 132, which interconnects the die 104 and the output shaft 116 via the respective pins 128, 136, causes the die 104 to move with the output shaft 116 toward to the retracted position.

If a user wishes to remove the die 104 (e.g., for replacement with another die to cut struts of a different geometry), the retaining arm 132 advantageously provides the shearing tool 100 with a tool-free, quick-change function. In particular, the user may grasp and/or press on an angled grip surface 144 (which, in the illustrated embodiment includes a plurality of grooves to enhance a user's grip on the grip surface 144), in order to move the retaining arm 132 in an unlocking direction (i.e. in the direction of arrow A in FIG. 6). The die retaining pin 136, which is fixed to the retaining arm 132, moves with the retaining arm 132 along a pin axis P and out of the bore 140 in the die 104 (FIGS. 6-8). In the illustrated embodiment, the pin axis P is perpendicular to and offset from the longitudinal axis L (FIG. 9). In some embodiments, the retaining arm 132 is biased toward the die 104 by a spring (not shown), such that the user must overcome the biasing force of the spring to move the retaining arm 132 in the unlocking direction of arrow A (FIG. 6).

Once the die retaining pin 136 is clear of the bore 140, the user may optionally rotate the retaining arm 132 about the first pin 128 to a disengaged position, in which the retaining arm 132 is misaligned with the angled slot 124. The user may then release the retaining arm 132, and the sides of output shaft 116 prevent the retaining arm 132 from moving back toward the die 104. As such, with the retaining arm 132 in the disengaged position, the user is free to use both hands, if desired, to slide the die 104 out of an open end 152 (FIG. 6) of the drive casing 112 (opposite the output shaft 116). The user may also insert a new die 104 through the open end 152. Once the new die 104 is fully inserted, the user may then rotate the retaining arm 132 back into alignment with the angled slot 124, and the spring (not shown) may then automatically move the retaining arm 132 toward the die to lock the die 104 with the die retaining pin 136.

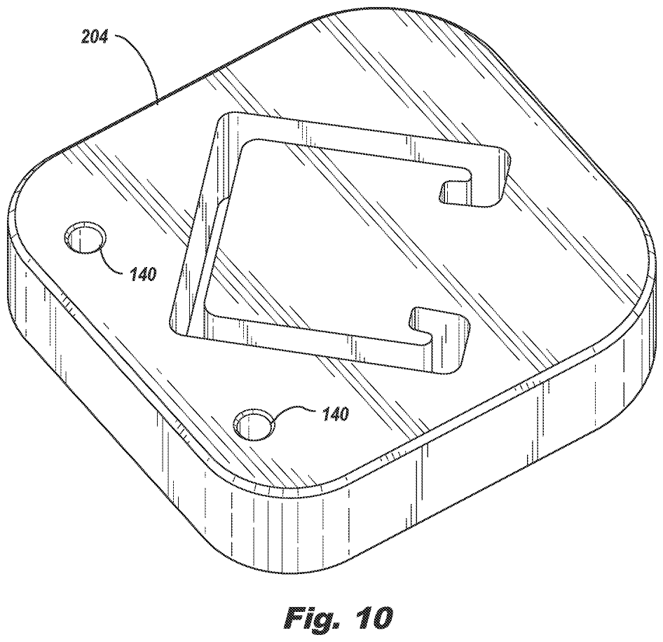

In another embodiment, illustrated in FIG. 10, a die 204, which may be used with the shearing tool 100 in place of the die 104 described above, includes a second bore 140 positioned symmetrically opposite the first bore 140 (e.g., with respect to the longitudinal axis L). By including two symmetrical bores 140, the die 204 is reversible, such that either bore 140 may align with and receive the die retaining pin 136 to retain the die 204. This reversibility may allow the die 204 to be more quickly and easily installed into the shearing tool 100.

Although the disclosure has been described in detail with reference to certain preferred embodiments, variations and modifications exist within the scope and spirit of one or more independent aspects of the disclosure as described.

Various features and aspects of the present disclosure are set forth in the following claims.

1. A shearing tool for shearing a strut channel, the shearing tool comprising:
a housing;
a drive casing coupled to the housing;
an output movable along a longitudinal axis relative to the drive casing between an extended position and a retracted position;
a die including
a front face,
a rear face opposite the front face,
a first bore extending through the front and rear faces,
a second bore extending through the front and rear faces,
a cutout extending through the front and rear faces, the cutout configured to receive the strut channel therethrough; and
a die retaining mechanism movable between a locked configuration, in which the die retaining mechanism couples the die to the output for movement therewith between the extended position and the retracted position, and an unlocked configuration, in which the die is removable from the drive casing,
wherein the die retaining mechanism is movable from the locked configuration to the unlocked configuration without the use of tools,
wherein the die retaining mechanism includes a die retaining pin, and
wherein the die is reversible such that the die retaining pin is received in the first bore when the die is in a first orientation and received in the second bore when the die is in a second orientation.

2. The shearing tool of claim 1, wherein the die removable from the drive casing through an open end of the drive casing.

3. The shearing tool of claim 2, wherein the open end is disposed opposite the output.

4. (canceled)

5. (canceled)

6. The shearing tool of claim 1, wherein the die retaining pin is withdrawn from the first bore and the second bore when the die retaining mechanism is in the unlocked configuration.

7. (canceled)

8. (canceled)

9. The shearing tool of claim 1, wherein the die retaining pin is supported on an arm pivotally coupled to the output.

10. (canceled)

11. The shearing tool of claim 1, wherein the cutout includes a back receiving portion configured to receive a back side of the strut channel, side receiving portions extending from the back receiving portion and configured to receive opposite sides of the strut channel, and hook-shaped lip receiving portions configured to receive lips of the strut channel.

12. The shearing tool of claim 11, wherein the back receiving portion and the side receiving portions define a first width, and wherein the lip receiving portions define a second width greater than the first width.

13. The shearing tool of claim 12, wherein the second width is between 45% and 75% greater than the first width.

14. The shearing tool of claim 11, wherein the die includes chamfers formed in the front face of the die on both inner and outer sides of the cutout.

15. The shearing tool of claim 14, wherein the chamfers define an included angle relative to the front face of the die between 30 degrees and 60 degrees.

16. A shearing tool for shearing a strut channel, the shearing tool comprising:
a housing;
a drive casing coupled to the housing;
an output movable along a longitudinal axis relative to the drive casing between an extended position and a retracted position;
a die including
a front face,
a rear face opposite the front face,
a cutout extending through the front and rear faces, the cutout configured to receive the strut channel therethrough; and
a die retaining mechanism movable between a locked configuration, in which the die retaining mechanism couples the die to the output for movement therewith between the extended position and the retracted position, and an unlocked configuration, in which the die is removable from the drive casing,
wherein the die is reversible relative to the drive casing such that the die is coupleable to the output via the die retaining mechanism in both a first orientation and a second orientation.

17. The shearing tool of claim 16, wherein the die removable from the drive casing through an open end of the drive casing opposite the output.

18. The shearing tool of claim 16, wherein the die includes a first bore extending through the front face and the rear face, and a second bore extending through the front face and the rear face, and wherein the first bore and the second bore are symmetrical about the longitudinal axis.

19. The shearing tool of claim 18, wherein the die retaining mechanism includes a die retaining pin received in the first bore when the die retaining mechanism is in the locked configuration and the die is in the first orientation and received in the second bore when the die retaining mechanism is in the locked configuration and the die is in the second orientation.

20. A die for shearing a strut channel, the die comprising:
a front face,
a rear face opposite the front face,
a cutout extending through the front and rear faces, the cutout including
a back receiving portion configured to receive a back side of the strut channel, side receiving portions extending from the back receiving portion and configured to receive opposite sides of the strut channel, and
lip receiving portions configured to receive lips of the strut channel,
wherein the die includes chamfers formed in the front face of the die on both inner and outer sides of the cutout.

21. The die of claim 20, wherein the back receiving portion and the side receiving portions define a first width, and wherein the lip receiving portions define a second width greater than the first width.

22. The die of claim 21, wherein the second width is between 45% and 75% greater than the first width.

23. The die of claim 20, wherein the chamfers define an included angle relative to the front face of the die between 30 degrees and 60 degrees.

24. The shearing tool of claim 16, wherein the die retaining mechanism is biased toward the locked position.

25. The shearing tool of claim 16, wherein the output includes a shoulder abutting a drive side of the die, and wherein the die retaining mechanism includes an arm coupled to the output and a die retaining pin extending from the arm, and wherein the arm is biased toward the die by a spring.
